(19) United States
(12) Patent Application Publication
(10) Pub. No.: US 2002/0069152 A1
(43) Pub. Date: Jun. 6, 2002

(54) Day trading system

(76) Inventors: Paul A.Adao e Silva B.C, New York City, NY (US); Robert I. Howard, Evanston, IL (US)

Correspondence Address: Stroock & Stroock & Lavan LLP, 180 Maiden Lane, New York, NY, 10038, US

(21) Appl. No.: 09/736,939

(22) Filed: Dec. 14, 2000

(51) Int. Cl. G06F 17/60

(52) U.S. Cl. 705/37; 705/36

(57) ABSTRACT

A securities trading game is provided wherein players can make buy and sell decisions by clicking buttons on the screen of a computer that are associated with one of a fixed number of securities, such as stocks. A system in accordance with the invention can present a player with a computer screen showing dollars in an account that can be used to make purchases and a fixed set of securities to purchase from the account, such as by clicking on a buy (and sell) button. The screen can also show winnings, in terms of gains or loses through fully consummated transactions, in which a security has been both bought and sold.

### BACKGROUND OF THE INVENTION

The invention relates generally to a computer game and more particularly to a system for buying and selling stocks with a computer.

It is possible to play many different types of games on a computer. For example, many computers are sold with a program for playing blackjack. Various internet web sites also permit users to play different types of games over the internet.

Many players find games to be insufficiently stimulating unless actual dollars or something of value is at stake. However, games for which actual dollars or something of monetary value are at stake can fall under the category of gambling and can be regulated by law.

Many people find day trading, particularly where stocks are purchased on-line, held a relatively short amount of time such as for mere seconds or minutes and then sold, to be particularly exciting. Although the dollars accumulated during a particular transaction might not be extraordinary, when multiple trades are made throughout the day, considerable wealth can be accumulated in a relatively short time. Likewise, considerable loses can be accrued in a relatively short amount of time. Thus, many individuals find day trading to be a highly stimulating activity.

Despite the excitement that can occur while day trading, it is only practiced by a relatively small percentage of people compared to the number of people who play games with their computer or who buy and sell stocks. Many individuals find the concept of day trading to be intimidating. It can be intimidating or inconvenient to set up an account with a brokerage house. Often, an individual does not want to put sufficient money at risk to meet the minimum requirements of a brokerage house. For some, because their personal volume of trades is relatively low, too much of their profits are eroded with trade commissions. Also, many individuals feel intimidated by the shear volume of different stocks that can be bought and sold and many find conventional day trading systems to be too difficult to use and not as much fun as games, such as casino games, horse racing or other forms of sports betting.

Accordingly, it is desirable to provide an improved system for day trading that is more fun, simple, convenient and easy to use than conventional systems.

### SUMMARY OF THE INVENTION

Generally speaking, in accordance with the invention, a system for securities trading is provided wherein players can make buy and sell decisions by clicking buttons on the screen of a computer that are associated with one of a fixed number of securities, such as stocks. A system in accordance with the invention can present a player with a computer screen showing dollars in an account that can be used to make purchases (and sales) and a fixed set of securities to purchase from the account, such as by clicking on a buy (and sell) button. The screen can also show winnings, in terms of gains or loses resulting from fully consummated transactions in which a security has been both bought and sold. The screen can present a fixed number of stocks from which to make buy or sell selections and optional links or buttons could provide more information about each of the stocks in the set. In addition to a buy and sell button, the screen can provide an indication of the stock's recent momentum, i.e., whether it has recently gone up or down in value. Various graphical presentations, such as arrows or rising or falling objects and/or graphs can make it relatively easy to determine which stocks are moving, the direction in which their prices are moving and historical highs and lows for the stock. Thus, a user need only click on a buy button to buy a selected dollar amount of the stock and click a sell button to sell a selected amount of the stock. A “sell all” button can also be included for a user to sell all of his holdings in a particular stock. Disconnecting will trigger all holdings to be sold.

Trading systems in accordance with embodiments of the invention, run by what can be referred to as a system manager can transmit buy and sell orders from multiple players, referred to as clients of the system manager into a host computer, which can be a system server controlled by the system manager. That system server can either execute the transactions, where the system manager is a brokerage house or forward the transactions to a brokerage house which will execute the transactions, preferably automatically by computer. In a preferred embodiment of the invention, a buy or sell order form a player/client will be executed in at least 5 seconds, more preferably in at least 2 seconds, more preferably less than 1 second.

Accordingly, it is an object of the invention to provide an exciting game that can be played on a computer.

Another object of the invention is to provide a system for making day trading more fun and simple.

### BRIEF DESCRIPTION OF THE DRAWINGS

For a fuller understanding of the invention, reference is had to the following description, taken in connection with the accompanying drawings, in which:

FIG. 1 depicts a client (player) interface screen in accordance with a preferred embodiment of the invention;

FIG. 2a is a flow chart of a client system in accordance with a preferred embodiment of the invention;

FIG. 2b is a flow chart for storing and displaying values in connection with the client system of FIG. 2a;

FIG. 2c is a system for displaying stock trends in connection with the client system of FIG. 2a;

FIG. 2d is a flow chart for handling buy and sell orders in connection with the client system of FIG. 2a;

FIG. 2e is a flow chart for displaying purchases and sales in connection with the client system of FIG. 2a;

FIG. 2f is a flow chart of a synchronized time system used in connection with a client system of FIG. 2a;

FIG. 3a is a flow chart for displaying stock values and stock trends in accordance with client handling details in connection with a preferred embodiment of the invention;

FIG. 3b is a flow chart invoked on the activation of buy or sell buttons for handling buy or sell orders in connection with a preferred embodiment of the invention;

FIG. 3c is a flow chart of a system invoked when an amount button is pressed for handling buy orders in connection with a preferred embodiment of the invention;

FIG. 3d is a flow chart of a system invoked when a dollar amount button is activated for processing sell orders in connection with a preferred embodiment of the invention;

FIG. 4a is a flow chart of a server system for processing service connection requests, client requests and transmitting financial data in accordance with a preferred embodiment of the invention;

FIG. 4b is a flow chart for handling service connection requests and transmitting financial data in connection with the server system of FIG. 4a;

FIG. 4c is a flow chart of a child server process for handling service client requests in connection with the server system of FIG. 4a;

FIG. 5a is a flow chart of server details for processing service broker receipts, service buy orders and service sell orders in accordance with a preferred embodiment of the invention; and

FIG. 5b is a flow chart for a service time synch request system in accordance with a preferred embodiment of the invention.

### DETAILED DESCRIPTION OF THE PREFERRED EMBODIMENTS

A securities trading game in accordance with the invention should be easy to use and fun to play. It should also have a responsive, highly graphical, simple to understand interface that allows an inexperienced securities trader, referred to herein as the client or player, to confidently buy and sell stock and the like within an abbreviated universe of stocks and without the fear of suffering unexpected financial losses.

One example of a day trading game in accordance with preferred embodiments of the invention, in which a client of a system manager hosting, operating or managing the trading system transmits buy and sell instructions to the system manager, who forwards the buy and sell instructions to a brokerage house, which is also a provider of price information, is set forth below, by way of non-limiting example.

As will be evident, there are many different ways of implementing the game. Also, as is evident, the game can be played without actual stock trades being executed and virtual gains and losses can be registered. Furthermore, the game can be managed by the brokerage house directly, without the use of an intermediate manager. In still other embodiments of the invention, the game manager can purchase a large volume of each of the stocks available for purchase and the clients' purchases and sales can be from the game manager's holdings, eliminating the need for a brokerage house to execute the transactions.

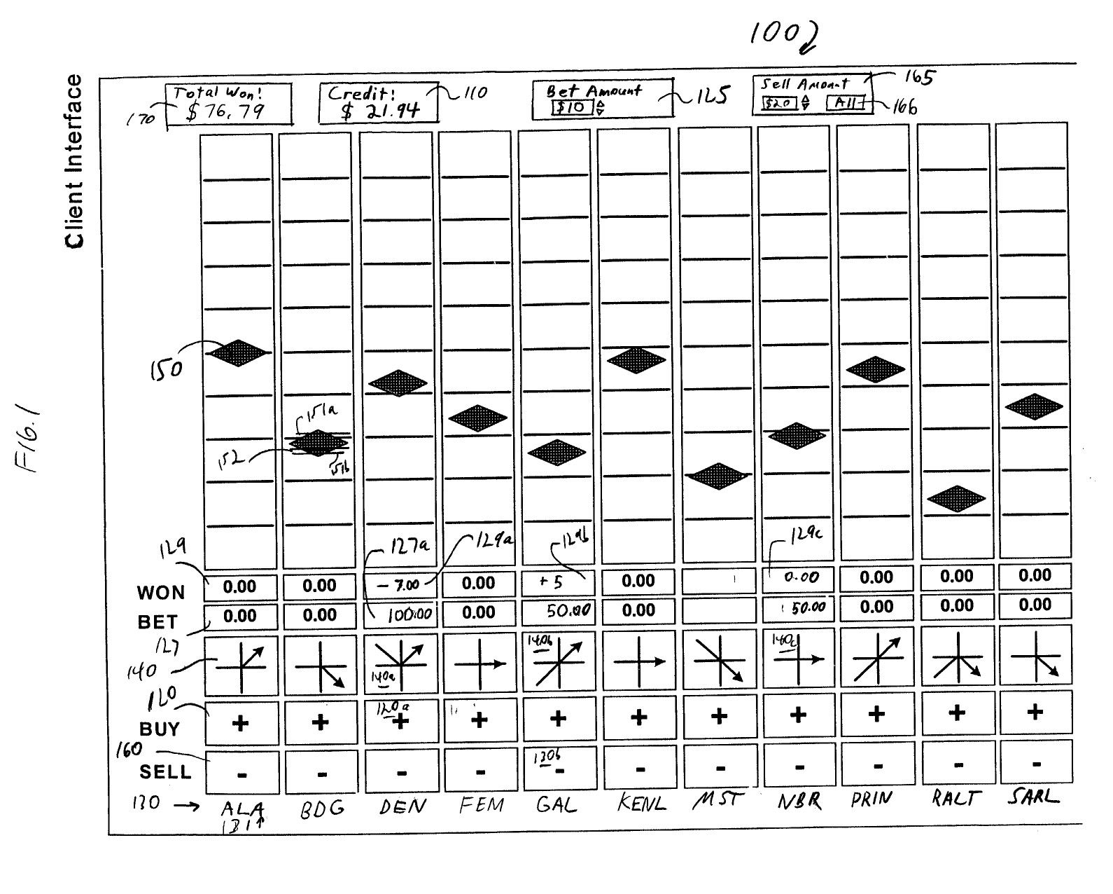

A client/player interface in accordance with a non-limiting preferred embodiment of the invention is shown generally as client computer screen 100, in FIG. 1. Screen 100 shows a credit amount indicator 110, whereby a client, either online, over the telephone or via some other means purchases credit to play the game. In one embodiment of the invention, a minimum initial purchase of for example $50.00 can be established. A maximum amount of perhaps $1,000.00 or $10,000.00 could also be established.

Payment can be effected in any number of known ways, such as by a check that was mailed in advance, electronically, by means of automated debiting from a checking or savings account or through a credit card purchase, which can be consummated either over the telephone, via mail or preferably, on-line. In one embodiment of the invention, a player fee is deducted from the initial purchase. This fee can be a one time fee, a daily fee, based on the number of trades consummated and deducted automatically from each trade, or eliminated entirely. In one embodiment of the invention, players play purely for fun and are given an arbitrary credit account of, for example, $1,000.00, with which to purchase stocks. In another related embodiment of the invention, the imaginary winnings can be converted to discounts, frequent flyer miles or some other item of perceived value.

After a credit amount 110 has been established, players purchase stock by using a mouse and clicking on one of a plurality of buy buttons 120, each of which is associated with a stock, identified by a letter code 130. In one embodiment of the invention, clicking one of the buy buttons 120 will activate a window wherein the dollar amount of stock to be purchased can be selected. In another embodiment of the invention, a bet amount per click indicator 125 is established by the player, who selects the amount to be purchased each time they activate a buy button 120. In certain embodiments of the invention, the amount bet per activation of buy button 120 is fixed at, $10.00, for example, so that $100.00 of stock could be purchased by clicking buy button 120 ten times. In other embodiment of the invention, the amount set per activation of buy button 120 can be defined by the player by adjusting the amount indicated in bet amount indicator 125. By way of example, if bet amount indicator 125 is set at $20.00, then pressing buy button 120a five times will establish a purchase order of $100.00 of a stock identified by the letters DEN.

Screen 100 includes options for purchasing and selling 11 different stocks, identified by their letter codes 130. As is understood, this universe of tradable stocks can be any arbitrary number, preferably from 5 to 20, advantageously over 10. Such stocks should be selected for their highly volatile nature. Stocks having a price of about under one dollar are often desirable. In certain embodiments of the invention, clicking on letters 130 will bring up additional information about the stock symbolized by letter code 130, such as the company's name, its business, financial information and stock performance.

Screen 100 also includes a plurality of columns 131, corresponding to a particular stock, and can also include a bet indicator 127 for each stock, which indicates the dollar value of the stock designated by letter code 130 that has been purchased. Thus, bet indicator 127a shows that $100.00 worth of DEN was purchased.

Screen 100 also includes a change in value indicator 129 for each stock. Change in value indicator 129 shows the dollar change in the indicated stock purchased, after the stock was purchased. Thus, change in value indicator 129a shows that stock DEN decreased $7.00 or 7% in its value since it was purchased. In the case of multiple purchases at different points in time, such that a first set of shares were purchased at a first stock price and then later, a second set of shares of the same stock were purchased at a different stock price, change in value indicator 129 will report the overall change in value on a cumulative basis.

By way of example, referring to a change in value indicator 129b, it can be seen that $50.00 worth of GAL were purchased and that those shares have increased $5.00 or 10% since the purchase or purchases. If a sell button 130b were activated at this point in time, the player will have won $5.00 and a winnings indicator 170 will increase in value by $5.00. The proceeds from a sale can be used to increase the funds indicated in credit indicator 110.

Referring to a change in value indicator 129c, it can be seen that $50.00 worth of NDR was purchased and that at this particular moment in time, the shares purchased have a value of $50.00, whether or not they experienced any interim increases or decreases in price.

To provide playing clients with additional information to assist in their buy and sell decisions, each column 131 includes a stock movement indicator 140 which shows how the stock associated with that column 131 has changed in price over a very recent period of time, which can be on the order of minutes or seconds, preferably showing stock movement over the most recent 15 to 120 seconds. Referring to a stock movement indicator 140a, if the stock movement indicators 140 show stock movement over the previous 60 seconds, it can be seen that the value of stock DEN increased in value over the last 30 seconds after having decreased over the prior 30 second period. Stock movement indicator 140b shows that stock GAL has been increasing over the last 60 seconds and stock movement indicator 140c shows that stock NDR has been flat over the last 60 seconds. As will be apparent to those of ordinary skill in the art, various other graphical depictions of stock movement, such as by bar graphs or other known means showing more precise movement over the time period selected can be substituted for the arrows shown in screen 100.

To provide still additional information with respect to the stocks, a series of floating diamonds 150 are provided to show stock price movement since the user logged on or the market opened and how the price changed since a stock was purchased. The values indicated by the diamonds are preferably updated at the resolution of the data stream providing price information, such as a data stream received from a broker server. The values should be updated at least once every 4 seconds, preferably at least about every 2 seconds and more preferably every second or better. Each diamond 150 can also be shown with respect to outside borders 151a and 151b which show historical highs and lows since login or since the stock was purchased as well as intermediate border 152, showing the purchase price. Intermediate border 152 can be made to disappear when the holdings are sold.

When a player determines that it is appropriate to sell some or all of its holdings in a stock, the player clicks a sell button 160 in the column 131 associated with the stock to be sold. In certain embodiments of the invention, clicking on sell button 160 will cause a window to appear, from which the client can select the dollar amount to be sold or to sell all of their holdings. In other embodiments of the invention, all of the client's holdings in the particular stock will be sold. In still other embodiments of the invention, the amount to be sold will be identical to the bet amount indicated in bet indicator 125, for each click of sell button 160. In yet other embodiments of the invention, a sell amount indicator 165 can be used to determine the amount to be sold when sell button 160 is activated. A sell all button 166 can also be included, such that when activated, clicking on a sell button 160 will sell all of the client's holdings in that particular stock.

One non-limiting example of an implementation system in accordance with the invention is a client/server/broker system with clients that are Web browsers, custom, point of sale terminals for use by clients, a system server and a brokerage house server for executing trades.

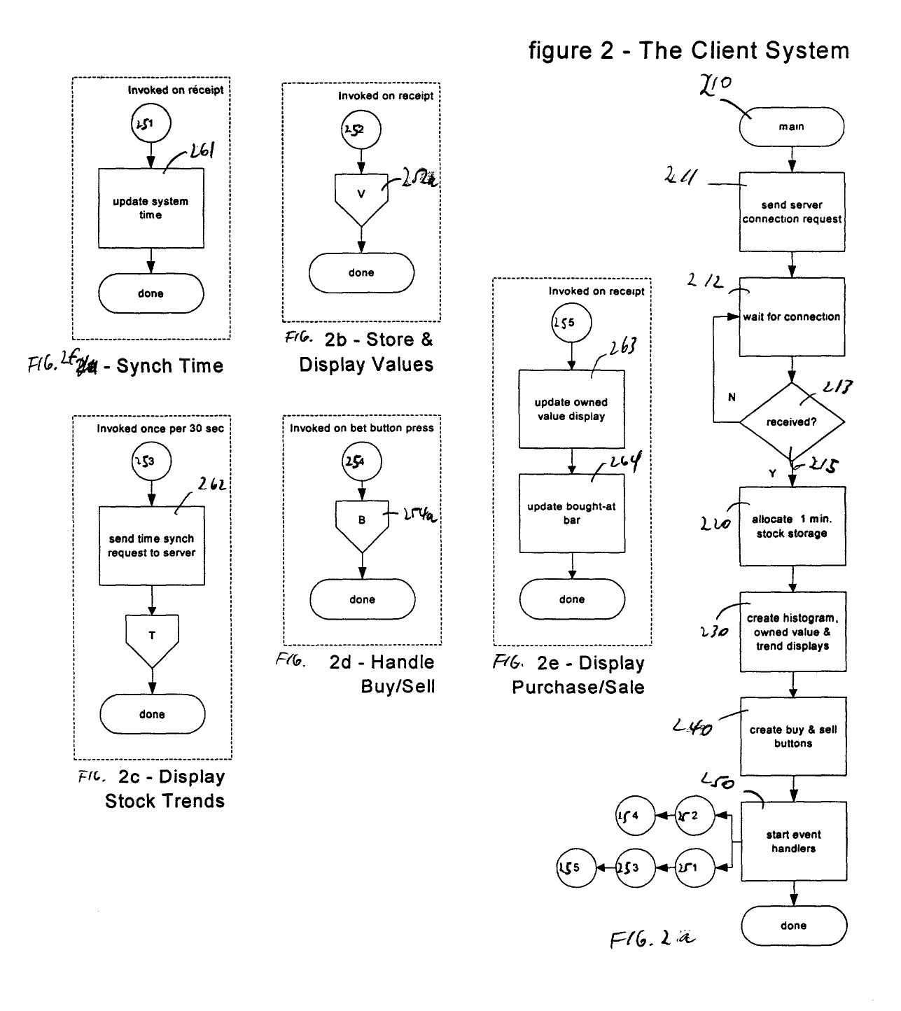

The client portion of a day trading system in accordance with one embodiment of the invention is shown in FIGS. 2a to 2f. The client portion of the system is responsible for establishing connection with the system server, gathering the clients' trades and displaying the stocks' current prices, historical trends and other indicators that the clients consult in order to make informed trading decisions. Other than gathering buy and sell orders, all information can be obtained from the server portion of the system.

As used herein, a “core” system is one that performs setup tasks such as memory allocation, event handler setups, and so forth. Other functions can be accomplished through the event handlers. It should be understood that initial implementation requires the presence of an event dispatch/handler mechanism. These are intrinsic to many modern windowing libraries or can easily be built according to well know designs.

FIG. 2a is a flow diagram of a core system illustrating the flow of the main client system. First, a main routine 210 sends a connection request 211 from a client to a system server that incorporates encrypted client identification data. The server waits for a connection 212, determines if one is received 213, and when received 215 the server responds that the connection is established and the client system allocates storage 220 sufficient to store a full minute (for example) of data for all of the stocks in the tradable set at 1-second resolution. This data can be used to calculate trend displays that will assist the client in making buy or sell decisions.

Next, several displays are created 230: a set of histograms, one per stock, which changes to reflect the current price and shows the historical high and low, and a set of trend indicators, again one per stock, which show historical price trends of the stock over the last minute (for example). A buy and a sell button are created for each stock 240. Activation of these can open sub-panels where the player can select the amount to be traded. Finally, the client installs five event handlers to implement the rest of the functionality 250:

Event Handler 251 handles server time synchronization packets;

Event Handler 252 stores and displays newly arrived price data;

Event Handler 253 updates historical trend indicators;

Event Handler 254 handles buy or sell requests; and

Event Handler 255 handles purchase receipts.

FIG. 2b is a flow chart for storing and displaying values. Invoked on receipt of a signal 252 from start event handler 251, the routine initiates a display value routine 252a.

FIG. 2c is a flow chart for displaying stock trends. In response to event handler 250, a time synch request 262 is sent to the system server. This can be invoked once every 30 seconds.

FIG. 2d is a flow chart for handling buy or sell orders from the client. It can be invoked by pressing a buy or sell button 254a and is discussed more filly below.

FIG. 2e is a flow chart for displaying purchases and sales. These are invoked on receipt of buy or sell instructions. In response to event handler 250, the display of the value of the stock owned is updated 263. The bought at bar, reflecting the price the stock was bought at is updated 264.

FIG. 2f is a flow chart for event handler 251, which handles the client's method of synchronizing the client's time with the system server time. Triggered on the receipt of time synchronization packet 251, previously requested from the server, the routine updates the client's application's private clock (updates system time) 261 to reflect the same time as the server. The method is essentially identical to that used in a standard Internet time synchronization protocol.

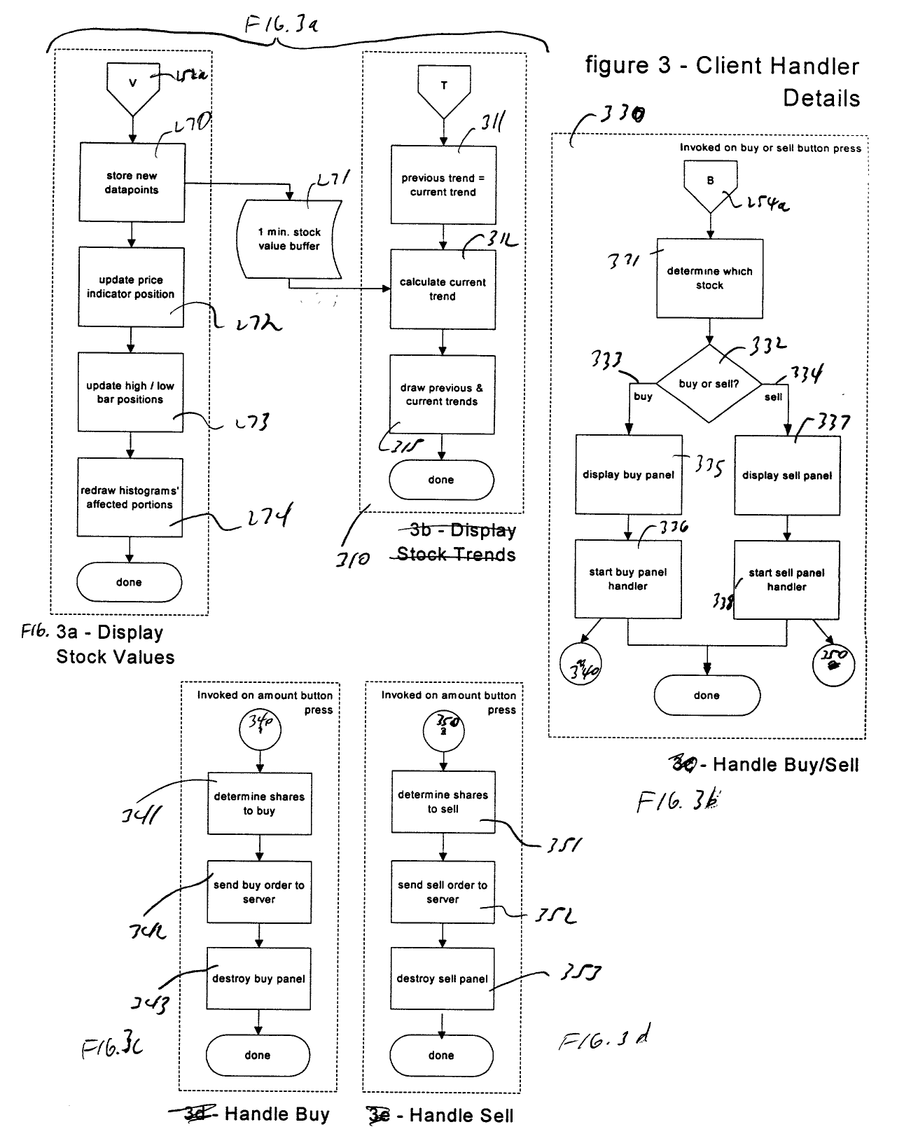

FIG. 3a is a flow chart showing the system's response to the arrival of a new set of stock prices from the broker, for displaying new stock values 252a. Triggered on receipt, the prices are stored as new data points 270. These are de-encrypted and stored in a stock value buffer 271. This storage 271, allocated to hold 1 minute (for example) worth of one-second-resolution (for example) prices for all stocks, will be used by the handler that calculates and displays the stock trend displays as discussed below.

Next, the histograms that are used to help the client visualize the stocks' prices are updated. For each stock, the new price value is scaled into the pixel display range of its associated histogram and the price indicator position is updated 272. Then, the current price is compared to the historical high/low of that stock since trading began. If the new price is above the high price or below the low price, the position of the appropriate indicator is recalculated 273 and the high/low bar positions are updated. Finally, the affected portions of the histogram's area are redrawn to reflect the changes 274.

Stock trends can then be displayed. Once every thirty seconds (for example), a stock trend handler 310 is invoked to display stock trends. In one embodiment of the invention, seven bitmaps are used to represent the stock's price trend over the last two 30 second periods. Alternate embodiments of the invention can include actual rendered line graphs with as little as 1-second resolution. For each stock, the current trend (i.e. rising, flat or falling) is stored as the previous trend 311. Then the current trend (based, in this implementation, on a simple moving average), is recalculated 312 using the most recent 30 seconds of price data from buffer 271. Then, one of the seven trend line bitmaps is selected based on the previous and current trends and drawn to the screen 315, overlaying the stock's previous trend line. Alternate embodiments of the invention can select from the wealth of indicators that technical stock analysts use to predict future price behavior.

Buy or sell orders can be processed as follows. The client's response to the player pressing the buy or sell button associated with a particular stock is illustrated by a client buy/sell handler 330 of FIG. 3b. Handler 330, initiated when a buy or sell button is pressed 254a, determines which stock the client wishes to trade 371 and then determines 332 whether the request represents a buy order 333 or a sell order 334. If the order is to buy 333, a buy panel, containing several fixed dollar value buttons, is displayed 335 and a buy panel handler 340 is installed 336. If the order is to sell 334, a sell panel, displaying a range of value buttons and one labeled “ALL” is displayed 337, and a sell panel handler 350 is installed 338.

Buy handler 340 can operate as follows. When the player presses one of the dollar value buttons on the buy panel, handler 340, detailed in FIG. 3c is triggered. The button's value is compared to the stock's price and the number of shares to buy is calculated 341. The buy order, consisting of the client's identity, the stock's identity and the number of shares to buy, is formatted, encrypted and sent to the system server 342. Lastly, the buy panel and it's handler are destroyed 343.

Sell handler 350, detailed in FIG. 3d, can operate as follows. When the player presses one of the dollar value buttons on the sell panel, displayed as a result of step 338, sell handler 350 is initiated. If the button has a dollar value, it is compared to the stock's price and the number of share's to sell is calculated 351. If the special “ALL” button is pressed, a special value is used that represents (to the server) the desire to sell all of the player's holdings of the identified stock. The sell order, consisting of the client's identity, the stock's identity and the number of shares to sell, is formatted, encrypted and sent to the server 352. Then, the sell panel and it's handler are destroyed 353.

Purchases and sales can be displayed as follows. When the client receives notification from the server that a stock trade has cleared the broker's server, the owned value display for that stock is updated to reflect the new number of shares owned, multiplied by the current price. If the client previously held no shares of the stock, a bought-at bar is drawn on the stock's histogram so that the client has a ready indication of their purchase price vs. the current price vs. the historical high and low. The bought at bar might be of a different color or character than the high and low.

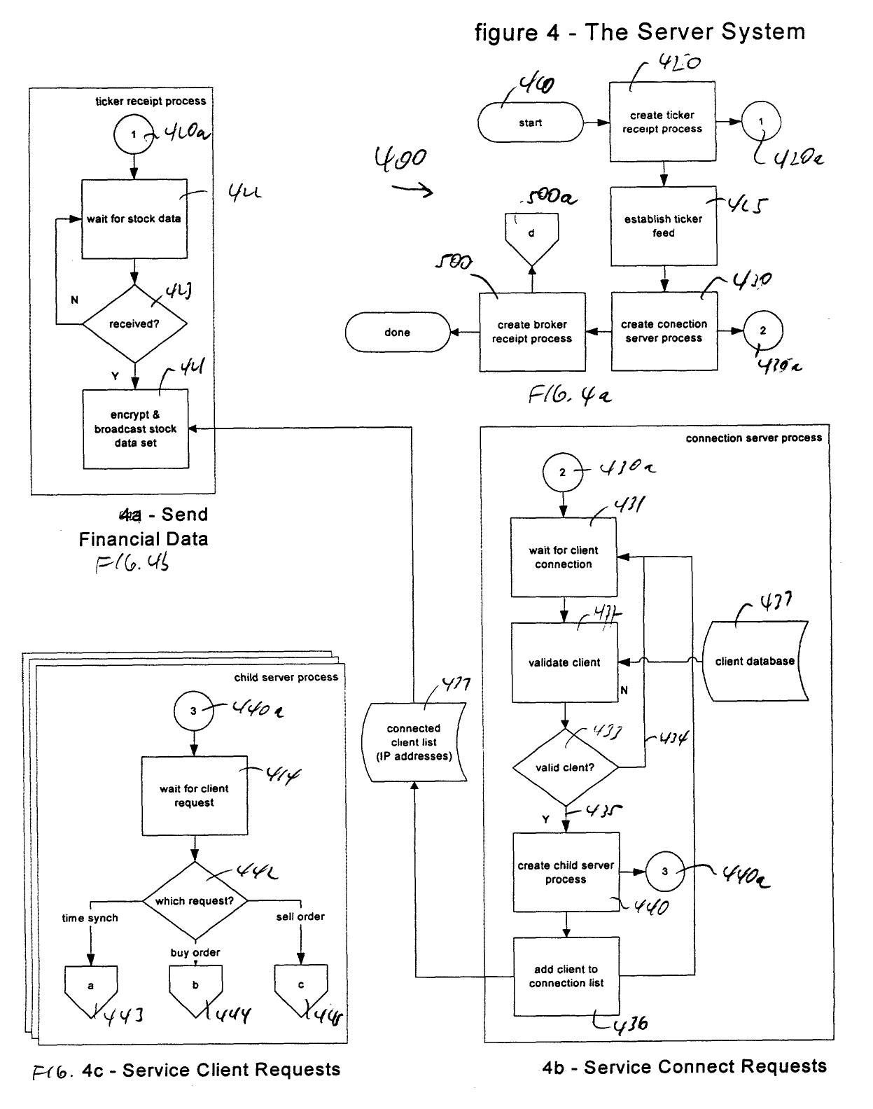

A day trading server system in accordance with an embodiment of the invention is shown generally as server 400 in FIG. 4a. Server portion 400 of systems in accordance with the invention can be very similar in design to many Internet servers (e.g. Web Servers). A connection manager process receives requests from qualified clients and spawns a separate process for each of them. These “child” processes service the requests of the clients that they are connected to.

In one embodiment of the invention, a second primary process manages the connection to the broker's real time data feed and encrypts and broadcasts that data to connected clients. A third process handles the receipt packets that the broker server sends to confirm a trade.

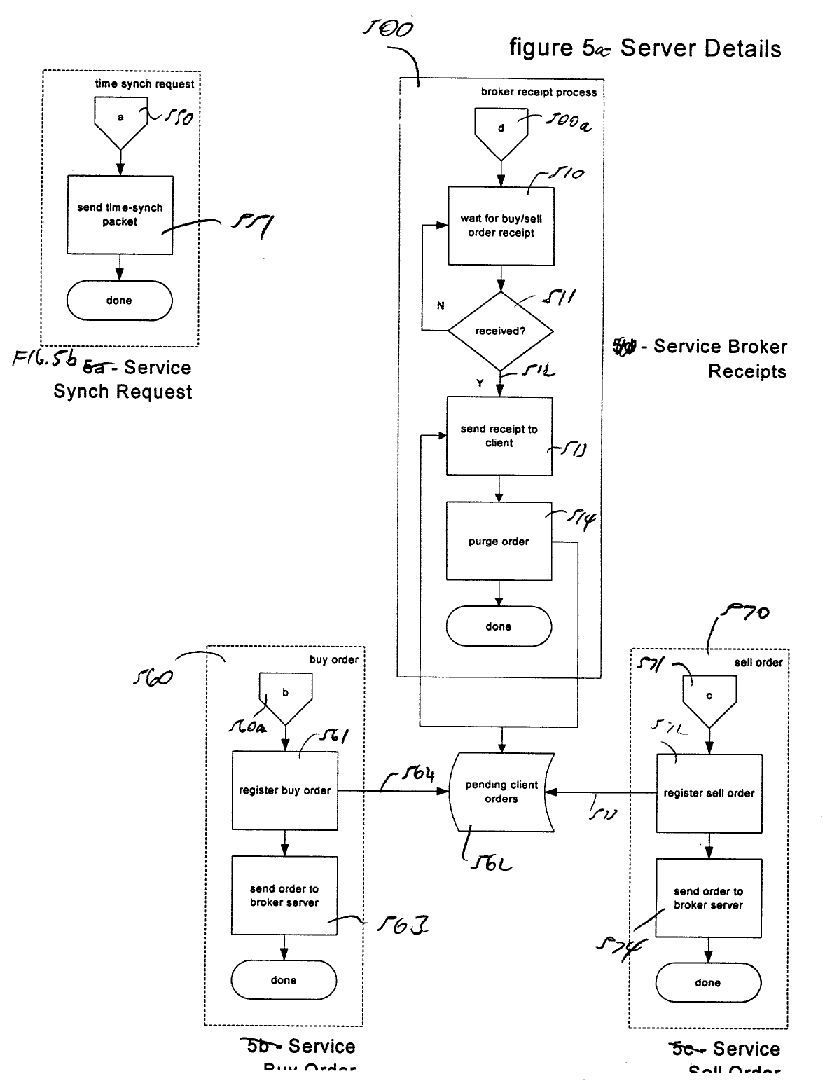

At startup 410, the server begins by initializing its real-time feed from a chosen broker. The nature of these connections varies from broker to broker. In this exemplary implementation, the system server registers with the broker's server and waits for packets on a particular port. Next, the server spawns three processes. The first, a create ticker receipt process 420, 420a waits on the real-time data feed's port for financial data packets from the on-line provider (the broker) of this information and broadcasts them to connected clients, creating a ticker feed process 425. After ticker feed 425 is established, a connection server process is created 430, 430a. Connection server process 430, 430a waits on the port that is used by the playing clients to communicate with the system server and services requests for client connections. In a third process, (FIG. 5a), a broker receipt process is created 500, 500a. Broker receipt process 500 waits for receipts from the broker server that confirm a trade.

FIG. 4b is a flow diagram of a ticker receipt process showing the response to received packets of financial data in accordance with a broadcast of financial data process. The system encrypts and broadcasts the price data as a stock data set 421. It then consults its list of playing clients and broadcasts the encrypted update to all of them. The information is encrypted once before it is stored. This can remove the overhead of communicating through a Secure Socket Layer (SSL), which re-encrypts the data each time it is requested. Thus, at ticker receipt process 420, 420a, the system server waits for stock data 422, checks if stock data is received 423 and if so, encrypts and broadcasts stock data set 421 to the playing clients.

A flow diagram for a connection server process is also shown in FIG. 4b, which shows the system server's response to a client's request for a connection. The server waits 431 for a client connection request 430a. When a connection request 430a is received, the server consults its database of authorized clients to validate the client 432, 433. A potential client can become an authorized client by registering, such as on line or otherwise. If the client does not have authorization 434, it waits 431 for the next request 430a. If the client does have authorization 435, the server spawns a separate child server process 440, 440a to handle that client. The client is added to the connection list 436, 437 and the client receives encrypted stock data sets 421 when broadcast.

A process to service client requests, i.e. child server process 440a is shown in FIG. 4c, which is a flow diagram of the functionality of the process that is spawned to service each client's connection. Process 440a awaits for a client request 441, determines the type of request 442 and establishes three event handlers, corresponding to each of the three possible client requests:

1. a request for time synchronization 443;

2. a client buy order 444; or

3. a client sell order 445.

When the connected client's request is received, the associated request handler is invoked.

A flow diagram of a broker receipts process 500, 500a is shown in FIG. 5a, which describes the function of the process that handles confirmations of buy/sell orders received from the broker server. The process waits 510 for these receipts, determines if one was arrived 511 and, when one arrives 512 the receipt is checked against the server's store of pending client orders. After matching the receipt to its client, the process forwards it to the associated client in encrypted form 513. Finally, the pending order is purged from storage 514.

In response to a client buy order, a buy order handler 560 is triggered. A buy order 560a is registered 561. The client ID and details of the buy order are added 564 to the pending orders store 562. The buy order is then sent to the broker server 563 in its own required format, which varies from brokerage service to brokerage service.

A sell order 570a is processed in accordance with a sell order process 570. In response to a client's order to sell a number of shares of a stock it is holding 570a, the routine registers the sell order 572 and stores 573 the client ID and details of the order in pending orders store 562. The sell order is then forwarded to the broker server 574 in its own required format.

FIG. 5b is a flow diagram which shows the server's response to a time synchronization request 550. The server sends a time synchronization packet to the client 551. The format of the packet, and the nature of the algorithms on either end, can be an implementation of the standard Internet Network Time Protocol (NTP) whose specifications are laid out in RFC119 and RFC1129, incorporated hereby by reference.

It will thus be seen that the objects set forth above, among those made apparent from the preceding description, are efficiently attained and, since certain changes may be made in carrying out the above method and in the constructions set forth without departing from the spirit and scope of the invention, it is intended that all matter contained in the above description and shown in the accompanying drawings shall be interpreted as illustrative and not in a limited sense.

What is claimed is:

1. A system for purchasing and selling securities, comprising:
a central server computer and at least one terminal electronically connected to the server, the server constructed to send information to the terminal, such information including the identities of a set of game securities, the game set of securities being a subset of and substantially smaller in number than the total set of tradable securities, the server also constructed to receive information from the terminals;
the terminal having a display presenting a user with (a) an identifier for each member of the game set of securities, (b) a periodically updated price display constructed to receive price information from the server and displaying the price at which each of the game set of securities can be purchased or sold, (c) a buy indicator, which when activated, transmits a signal from the terminal to the server, indicating an order to buy a specified amount of a specified security on behalf of the user of the terminal, (d) a sell indicator, which when activated, transmits a signal from the terminal to the server indicating an order to sell a specified amount of a specified security on behalf of the user of the terminal, (e) a value display indicating the value of each security after it has been purchased, the value display periodically updating the value of the stock as its price changes with time, and (f) an account indicator indicating the amount of money available for purchasing securities;
the server constructed to process the buy and sell orders received from the terminal on behalf of the user of the terminal.

2. A method of buying and selling securities comprising:
establishing an account with a system manager, the account having a selected dollar value to be used to purchase securities, the account associated with a computer terminal;
displaying at the computer terminal (a) the amount in the account, (b) screen identifiers identifying the game securities and (c) prices for the pre-selected set of game securities, the set of game securities being a relatively small subset of all tradable securities which can be bought with funds from the account and sold to replenish funds into the account, the identities of the game securities selected by and received from a central system server electronically connected with the terminal;
periodically updating the displayed prices for buying and selling the game securities;
using the terminal to purchase a selected amount of at least one of the game securities by activating a buy indicator at the terminal and electronically transmitting a corresponding purchase order to the system server to execute the purchase of the selected amount of the selected securities, updating the account display by deducting the purchase price of the securities purchased from the account and displaying the amount of the securities purchased;
selling a selected amount of a selected security by activating a sell indicator and electronically transmitting a corresponding sell order to the system server to execute the sale of the selected amount of the security and updating the account display to include the proceeds from the sale.

3. The method of claim 2, wherein the set of game securities consists of about 5 to 20 different securities.

4. The method of claim 2, wherein the game securities comprise about 5-20 different stocks having a price of less than one dollar.

5. The method of claim 2, wherein the value of each security purchased is displayed and the display is updated as the price of the security changes with time.

6. The method of claim 2 wherein a change in value indicator displays how the value of each security purchased changes from the time it was purchased.

7. The method of claim 2, wherein the system server receives buy and sell orders from the terminals and transmits them to a broker server to execute the purchases and sales of the securities indicated in the orders.

8. The method of claim 7, wherein the broker server sends the time varying price information for the game securities to the system server and the system server distributes such price information to the terminals.

9. The method of claim 2, wherein the users of the terminals are web browsers.

10. The method of claim 2, wherein the terminal display provides each game security with an individual point and click activatable buy button and sell button for buying and selling selected amounts of the security.

11. The method of claim 2, wherein the terminal display provides each game security with an associated recent change in value indicator, showing how the security changed in value over about the most recent 15 to 120 seconds.

12. The method of claim 3, wherein the terminal display provides each game security with an associated recent change in value indicator, showing how the security changed in value over about the most recent 15 to 120 seconds.

13. The method of claim 4, wherein the terminal display provides each game security an associated recent change in value indicator, showing how the security changed in value over about the most recent 15 to 120 seconds.

14. The method of claim 2, wherein a graphical presentation of the changes of the security's value with time is displayed for each game security.
